(19) United States
(12) Patent Application Publication
(10) Pub. No.: US 2015/0117077 A1
(43) Pub. Date: Apr. 30, 2015

(54) AC / DC POWER BANK DISTRIBUTION MANAGEMENT SYSTEM

(71) Applicant: Multi-Expander Technology Inc., New Taipei City (TW)

(72) Inventors: Tang-Hsien Huang, New Taipei City (TW); Hsien-Tang Weng, New Taipei City (TW); Che-Yu Lin, New Taipei City (TW)

(21) Appl. No.: 14/315,339

(22) Filed: Jun. 26, 2014

(30) Foreign Application Priority Data
Oct. 30, 2013 (TW) 102220187

(51) Int. Cl. H02M 7/00

(52) U.S. Cl. CPC H02M 7/003
USPC 363/144

(57) ABSTRACT

An AC/DC power bank distribution management system is provided, which includes a power supply unit, a power distribution board and a power distribution unit. The power source includes the alternating current (AC) or direct current (DC) that is converted into a low-voltage DC by a high efficiency power supply unit. Then, the power distribution board adjusts the transmission mode for providing a direct current with safe, stable and low-voltage. Thus, for the AC/DC power bank distribution management system, the power consumption value refers to a real power consumption usage value in the server system operator which can provide a fair electricity data for the telecommunications system operators and the server system to save the electricity expenses for the server system.

### FIELD OF THE INVENTION

The present invention relates to a power bank distribution management system, and more particularly to a power bank distribution management system for converting alternating current (AC) or direct current (DC) into a low-voltage DC and the low-voltage DC is supplied for operating the server system.

### BACKGROUND

As the advance of computer industry is developed increasingly, and the enterprises are also dependent on the industrial computer systems day by day. The industrial computer usually refers to a heavy-duty computer that can sustain a 24-7 operation. For example, the industrial computer includes core control equipment for the factory automation, Web servers and data backup servers for the enterprises, and so on.

With the development of electronic technology and industry computer-related applications, the industry has relatively higher requirement for server systems. For the growth of enterprises, many enterprises usually integrates a multiple of server units into the computer chassis and is incorporated with a plurality of computer chassis to form a set of industry computer to cope with the amount of data generation or internet traffic, and can deal with the upgrade or expansion for the server system in the future.

In general, a set of industry computer may include a multiple of system chassis and each system chassis further includes a plurality of single board computer unit (for example a blade computer). When each the single board computer arranges the power supply and the power lines respectively in the industry computer, the single board computer will occupy a huge space and the system is not easily to maintain. In addition, large number of power supplies requires a plurality of transformers and coils that increase the manufacturing cost, waste the resources and reduce power usage efficiency.

For example, the input power for each server unit, storage unit and the internet unit within the traditional data center is received the AC voltage which is typically transferred from the power company. The internal circuitry requires a stable direct current in each server unit, the storage unit and the internet unit and above components is respectively equipped with their own power supplier to provide the power requirement. However, the hundreds to thousands of calculation system unit, storage system unit and communication system unit of the traditional data center equipped with individual power supply that will waste the manufacturing source and cost.

### SOME EXEMPLARY EMBODIMENTS

According to above drawback of the conventional prior art, the present invention mainly provides an AC/DC power bank distribution management system, in which the AC/DC power bank distribution management system converts alternating current (AC) or direct current (DC) into a low-voltage DC and provides a stable low-voltage DC to a server system, such that the power supply value is provided by the AC/DC power bank distribution management system that is a real power consumption usage value, and the electricity power efficiency can achieve higher than 90% and save the power expense of server system.

The objective of the present invention is to set a parallel mode, a redundant mode, or a parallel/redundant common mode on the power distribution board of the power distribution unit to output the low-voltage DC to the power bank distribution unit.

Another objective of the present invention is that the power distribution board with a protection function for monitoring the over-voltage (OVP), over-current (OCP), under-voltage (UVP) and short circuit, such that malfunctions of the power units can be interrupted by the power distribution board to avoid the abnormalities of the power supply going to the power distribution unit, and then damage the server system.

It is another objective of the present invention is that the power distribution board can monitor the electrical connection between the power supply unit and the server system. When the connection signal is not turned on or is abnormal, the power distribution board will interrupt the DC to pass through the power distribution unit, such that the server system can be protected from damaging the back-end server system to loading current under the abnormal connection.

It is still another objective of the present invention is that the power distribution board can provides the detectable and measurable power consumption usage value for the low-voltage DC for the server system.

It is another objective of the present invention is that the power distribution unit can prevent the over-current (OCP), over-voltage (OVP), over-temperature (OTP), and short circuit and under-voltage (UVP) to maintain the AC/DC power bank distribution management system under normal operation and provide a stable low-voltage DC into the server system.

It is an objective of the present invention is that the direct voltage is a low voltage in the power distribution unit such that the power supply unit can be hot-plugged individually under boot state, or the power supply unit can be cold-plugged, such that the operation of the AC/DC power bank distribution management system or the server system will not be affected and the repairs is not to be electric shocked which is exposed to the environment with lower DC-voltage.

It is an objective of the present invention is that the AC/DC power bank distribution management system is a high-efficiency saving-energy device, the power consumption is generated when the power is converted by the power supply unit and the power distribution board is provided for transmitting the low-voltage DC with very few power consumption. Thus, the amount of the power consumption is calculated by power distribution unit that is the actual electricity power consumption for the user. Thus, user does not need to pay the power consumption charges when the power is converted by the power supply unit before the power distribution board.

According to above objectives, the present invention provides an AC/DC power bank distribution management system includes a power supply unit, a power distribution board and a power distribution unit, in which the power distribution board is electrically connected with the power supply unit and the power distribution unit. The power supply unit is electrically connected with the power source includes the alternating current (AC) or direct current (DC) and converts the AC or DC into a low-voltage DC. The power distribution board receives the low-voltage DC which is transmitted from the power supply unit and the low-voltage DC is outputted according to a transmission mode which is selected by the power distribution board. The power distribution unit receives the low-voltage DC which is transmitted from the power distribution board, and the low-voltage DC is branch-outputted into the server system.

According to above objectives, the present invention also provides another AC/DC power bank distribution management system which includes a power supply unit and a power distribution unit, in which the power supply unit is electrically connected with the power distribution unit. The power supply unit is electrically connected with the power supply which includes alternating current (AC) or direct current (DC). The power distribution unit receives a low-voltage DC which is outputted from the power supply unit and the low-voltage DC is branch-outputted according to a transmission mode which is built-in the power distribution unit.

The present invention further provides an AC/DC power bank distribution management system applied for the server system, which includes a power supply unit, a power distribution board, a power distribution unit and a server system, in which the power supply unit is electrically connected with the power sources which includes alternating current (AC) or direct current (DC) and AC or DC is converted into the low-voltage DC. The power distribution board is electrically connected with the power supply unit and receives the low-voltage DC which is transferred from the power supply unit and outputted the low-voltage DC according to a transmission mode which is selected by the power distribution board. The power distribution unit is electrically connected with the power distribution board which receives the low-voltage DC from the power distribution board and is branch-outputted the low-voltage DC. The server system is electrically connected with the power distribution unit and the server system includes at least one server unit. The server system receives the low-voltage DC which is outputted from the power distribution unit to operate, and the power distribution unit provides the detectable and measurable power consumption usage value of the low-voltage DC for the server system.

According to above objectives, the present invention also provides an AC/DC power bank distribution management system applied for the server system, which includes a power supply unit, a power distribution unit, and a server system, in which the power distribution unit is electrically connected with the power supply unit and the server system respectively. The power supply unit is electrically connected with the power sources which includes alternating current (AC) and direct current (DC), and converts the AC and DC into a low-voltage DC. The power distribution unit receives a low-voltage DC from the power supply unit and the low-voltage DC is branch-outputted according to a transmission mode of the power distribution unit. The server system is electrically connected with the power distribution unit and the server system includes at least one server unit. The server system receives the low-voltage DC which is branch-outputted from the power distribution unit and the power distribution unit provides the detectable and measurable power consumption usage value of the low-voltage DC for the server system.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1A is a cross-sectional view of AC/DC power bank distribution management system in accordance with the present invention disclosed herein;

FIG. 1B is a cross-sectional view of back-end of the AC/DC power bank distribution management system in accordance with the present invention disclosed herein;

FIG. 2 is a block diagram of the AC/DC power bank distribution management system in accordance with the present invention disclosed herein;

FIG. 3 is a block diagram of another embodiment of the AC/DC power bank distribution management system in accordance with the present invention disclosed herein;

FIG. 4 is a block diagram of the AC/DC power bank distribution management system applied for the server system in accordance with the present invention disclosed herein; and

FIG. 5 is a block diagram of another embodiment of the AC/DC power bank distribution management system applied for the server system in accordance with the present invention disclosed herein.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims

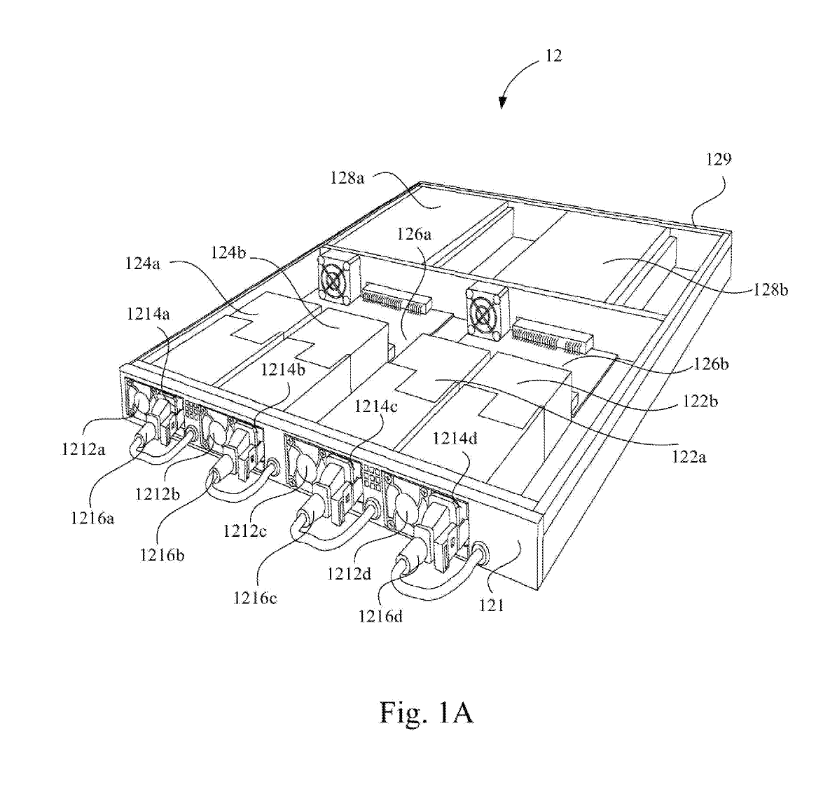

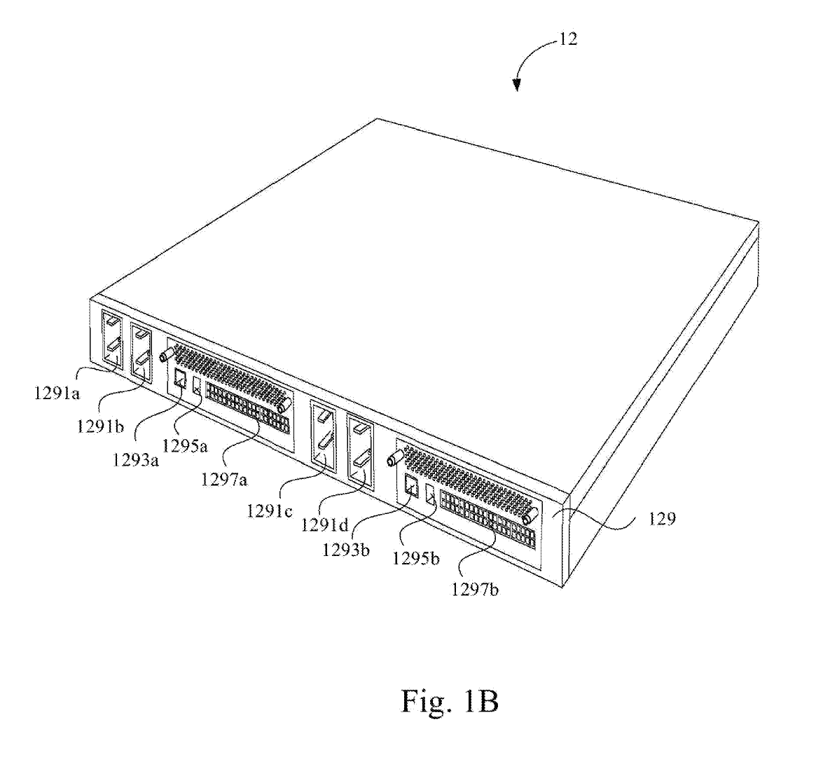

Please refer to FIG. 1A and FIG. 1B. FIG. 1A is a cross-sectional view of the AC/DC power bank distribution management system and FIG. 1B is a cross-sectional of back-end of the AC/DC power bank distribution management system. As shown in FIG. 1A, the AC/DC power bank distribution management system 12 includes a plurality of power supply units 122a, 122b, 124a, 124b, at least two power distribution boards 126a, 126b and at least two power distribution units 128a, 128b, in which the power distribution boards 126a, 126b is electrically connected with the power supply units 122a, 122b, 124a, 124b and the power distribution units 128a, 128b. The power supply units 122a, 122b, 124a, 124b is electrically connected with the power source (not shown), in which the power source can be alternating current (AC) or direct current (DC). The power distribution unit 128a, 128b is electrically connected with the server system (not shown) through the back-end 129 of the AC/DC power bank distribution management system 12. Furthermore, the front-end 121 of the AC/DC power bank distribution management system 12 includes the plurality of power supply units 122a, 122b, 124a, 124b, a plurality of fans 1212a, 1212b, 1212c, 1212d, a plurality of power cord tanks 1214a, 1214b, 1214c, 1214d, and a plurality of power cords 1216a, 1216b, 1216c, 1216d, in which each the plurality of power cords 1216a, 1216b, 1216c, 1216d is disposed in corresponded each the plurality of power cord tanks 1214a, 1214b, 1214c, 1214d respectively.

Furthermore, FIG. 1B shows a plurality of power sockets 1291a, 1291b, 1291c, 1291d, an internet connection ports 1293a, 1293b, at least two signal connection ports 1295a, 1295b and at least two connecting terminals 1297a, 1297b that are arranged on the back-end 129 of the AC/DC power bank distribution management system 12, in which the power sockets 1291a, 1291b, 1291c, 1291d is electrically connected with the server system (not shown), the internet connection ports 1293a, 1293b is electrically connected with the computer (not shown) and the connecting terminals 1297a 1297b is electrically connected with the server system which includes at least one server unit (not shown) . However, the connection and the function of the devices on the back-end 129 or front-end 121 of the AC/DC power bank distribution management system 12 is a well-known technique, so that it is not mainly implementation of the present invention and, and it is not described in detail herein.

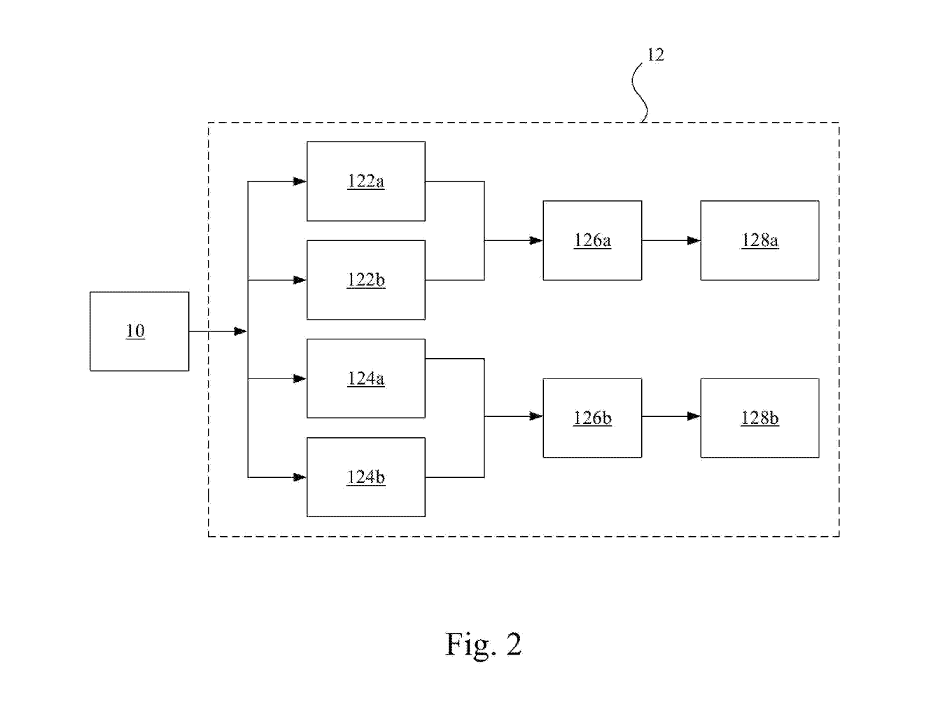

Please refer to FIG. 2. FIG. 2 is a block diagram of the AC/DC power bank distribution management system. As shown in FIG. 2, the AC/DC power bank distribution management system 12 is electrically connected with the power source 10. The AC/DC power bank distribution management system 12 includes a plurality of power supply units 12a, 122b, 124a, 124b, at least two power distribution boards 126a, 126b, and at least two power distribution units 128a, 128b, in which the power distribution boards 126a, 126b are electrically connected with the plurality of power supply units 122a, 122b, 124a, 124b and the power distribution units 128a, 128b.

won; In this embodiment, the plurality of power supply units 122a, 122b, 124a, 124b receives alternating current (AC) or direct current (DC) from the power, source 10 and converts a AC or DC into a low-voltage DC, in which the voltage of AC is in range from 100 volts to 240 volts and the voltage of DC is in range from 10 volts to 24 volts. After AC or DC is converted into the low-voltage DC by the power supply units 122a, 122b, 124a, 124b, the low-voltage DC is transferred within the AC/DC power distribution management system, in which the voltage of the low-voltage DC is in range from 10 volts to 24 volts.

The power distribution boards 126a, 126b receive the low-voltage DC from the power supply units 122a, 122b, 124a, 124b, in which the current transmission mode can be primary built in the power distribution boards 126a, 126b by the jumper (not shown) or the transmission mode can be written with the way of firmware in the power distribution boards 126a, 126b on the control chip (not shown). The transmission mode includes a parallel mode, a redundant mode, or a parallel/redundant common mode. Thereby, the power distribution boards 126a, 126b can distribute the low-voltage DC into the power distribution units 128a, 128b through aforementioned transmission modes.

Furthermore, the power distribution boards 126a, 126b is capable of monitor function for monitoring the low-voltage DC that is provide by power supply units 122a, 122b, 124a, 124b is under-voltage. For example, when the loading voltage of the motherboard (not shown) in the server unit (not shown) of the back-end server system (not shown) is 12 volts, the voltage of the DC of the power supply units 122a, 122b, 124a, 124b is over 12 volts, then the power distribution boards 126a, 126b will interrupt the electrical connection between the power distribution units 128a, 128b and power distribution boards 126a, 126b to avoid the DC with over-voltage which is passed through the power distribution units 128a, 128b to the back-end server system (not shown) to damage the equipment such as server system due to the over-voltage. In addition, the power distribution boards 126a, 126b is further capable of the protection function for the power supply units 122a, 122b, 124a, 124b, the protection function such as over-voltage, over-current, under-voltage and short circuit.

In addition, the power distribution boards 126a, 126b also monitors the connection signal between the power distribution units 128a, 128b and the server system (not shown). When the connection signal between the power distribution units 128a, 128b and the server system (not shown) is abnormal, the power distribution boards 126a, 126b will interrupt the connection status to become the breakage and will not execute the power supply units 122a, 122b, 124a, 124b, such that the power supply units 122a, 122b, 124a, 124b cannot provide power supply to prevent the abnormal power supply is provided for the non connection statute, and to prevent the equipment from damaging.

The power distribution units 128a, 128b is electrically connected with the power distribution boards 126a, 126b. The power distribution unit 128a, 128b receives the low-voltage DC from the power distribution boards 126a, 126b and branch-outputs the low-voltage DC to each the server unit in the server system. In addition, the power distribution units 128a, 128b can provides the detectable and measurable power consumption usage value of the low-voltage DC. In addition, the power distribution units 128a, 128b can provides the protection function such as over-voltage, over-current, over-temperature, under-voltage and short circuit.

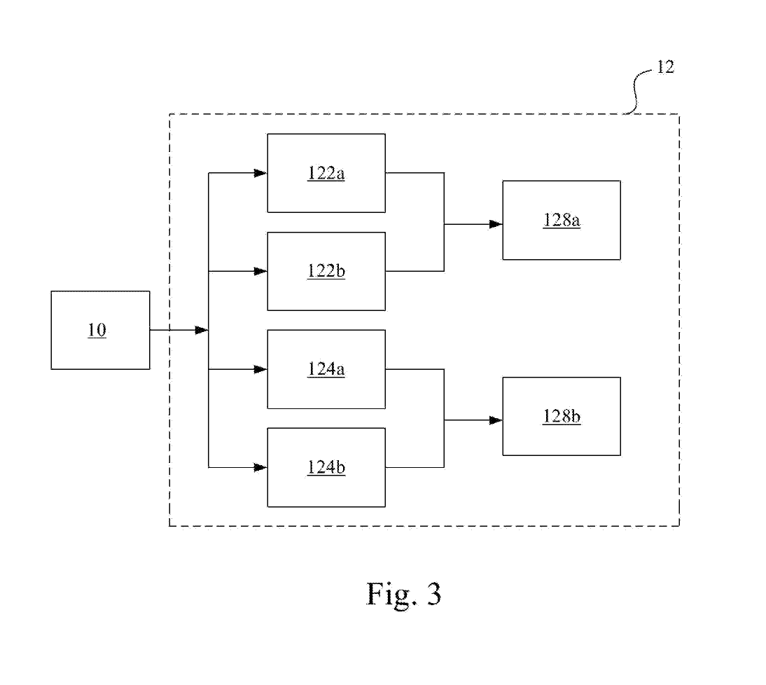

Please refer to FIG. 3. FIG. 3 is a block diagram of another embodiment of AC/DC power bank distribution management system. In FIG. 3, the power distribution boards 126a, 126b are incorporated with the power distribution units 128a, 128b in FIG. 2 to reduce the accommodation space in the AC/DC power bank distribution management system 12. It is noted to illustrate that the function of the power distribution board 126a, 126b is incorporated with the power distribution units 128a, 128b such that the power distribution units 128a, 128b not only branch-outputs the low-voltage DC but also includes the monitor function of the original power distribution boards 126a, 126b. The function, the operation and the electrical connection between the power source 10, the power supply units 122a, 122b, 124a, 124b and the power distribution units 128a, 128b are same as the aforementioned, and it is not described in detail herein.

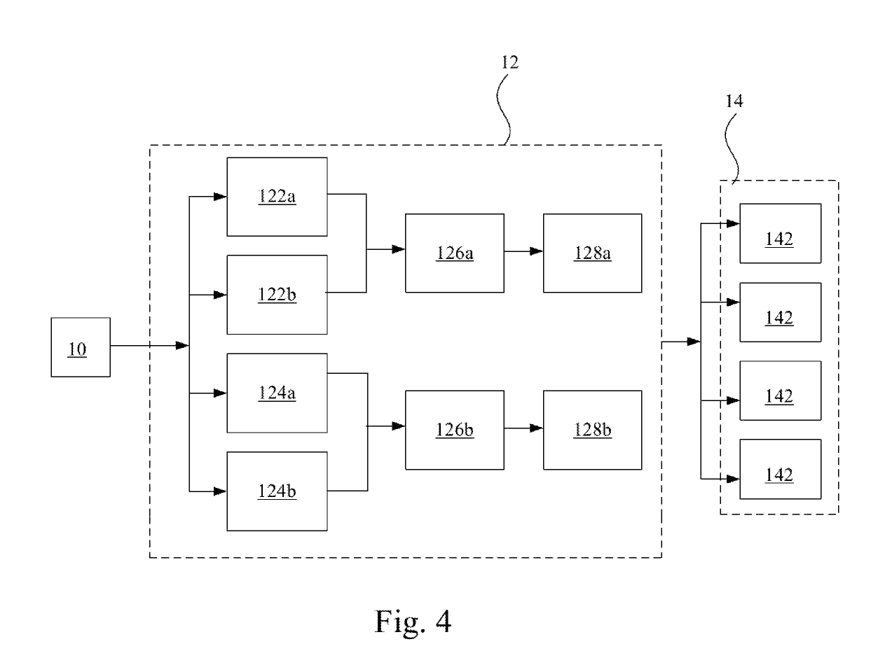

Please refer to FIG. 4. FIG. 4 is a block diagram of AC/DC power bank distribution management system applied for system. In FIG. 4, the AC/DC power bank distribution management system 12 of FIG. 2 is electrically connected with a server system 14. In this embodiment, the server system 14 includes at least one server unit 142. According to aforementioned, when the AC/DC power bank distribution management system 12 is electrically connected with the power supply source 10 with AC or DC, the power supply units 122a, 122b, 124a, 124b converts the power supply with AC or DC into a low-voltage DC with a voltage is in range from 10 volts to 24 volts and the preferable voltage value is 12 volts or 19 volts.

Then, the power supply units 122a, 122b, 124a, 124b transmits the low-voltage DC to the power distribution boards 126a, 126b. Typically, in the normal operation, the transmission mode in the power distribution boards 126a, 126b is set as parallel mode. Thus, the low-voltage DC is outputted to the power distribution boards 126a, 126b by the power supply units 122a, 122b, 124a, 124b and then the low-voltage DC is outputted to the power distribution units 128a, 128b. Moreover, each power supply units 122a, 122b, 124a, 124b can provide power at an efficiency of 90% for at least 3200 watt (W) in parallel mode of this embodiment.

In addition, each connection end between the power distribution units 128a, 128b and the server system 14 includes at least four connection terminals 1297a, 1297b (as shown in FIG. 1B). Each the connection terminals 1297a, 1297b are electrically connected with each the server unit 142 of the server system 14 respectively. Thus, the power distribution units 128a, 128b can beach-output the low-voltage DC into each the server units 142 of the server system 14 and provide the power supply for operating the server unit 142. It is noted to illustrate that the low-voltage DC is branch-outputted to each the server unit 142 is a constant voltage. That is, when the power supply units 122a, 122b, 124a 1,14b converts the power source 10 with AC or DC into the low-voltage DC, the voltage of the low-voltage DC is 12 volts, such that the DC is passed through the power distribution boards 126a, 126b and the power distribution units 128a, 128b is also 12 volts. Further, the voltage of DC is branch-outputted to each the server unit 142 of the server system 14 by the power distribution units 128a, 128b is also 12 volts. Obviously, DC is transmitted in the AC/DC power bank distribution management system 12 is a stable low-voltage DC, and the effective and stable power supply is outputted to the power distribution units 128a, 128b and is further supplied to the server system 14, so that the server system 14 can maintain stable operation.

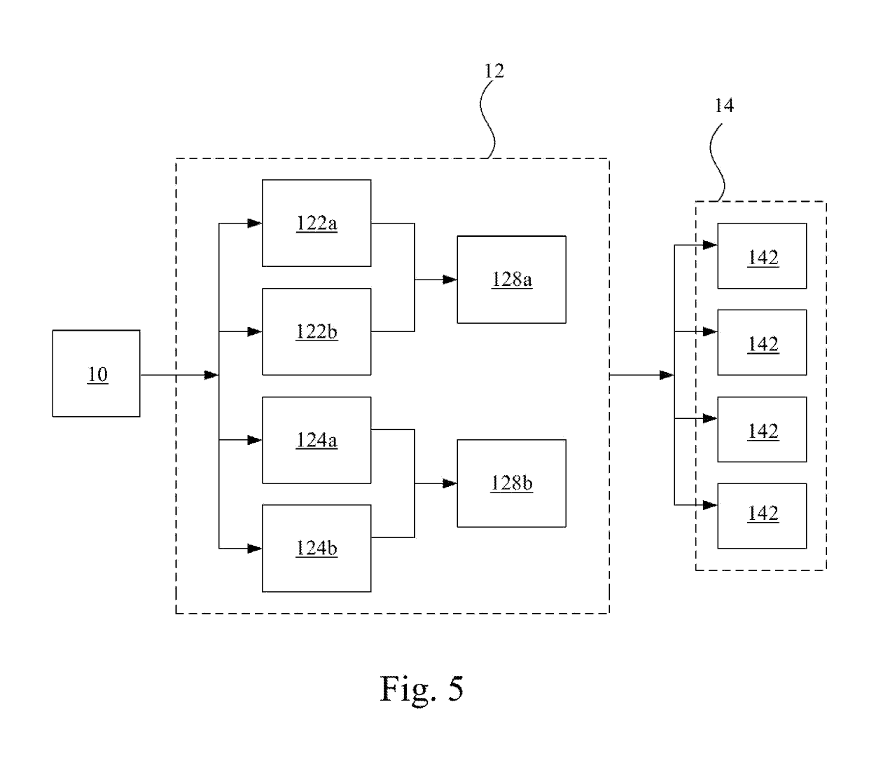

Furthermore, please refer to FIG. 5. FIG. 5 is a block diagram of another embodiment of AC/DC power bank distribution management system applied for server system. In FIG. 5, the AC/DC power bank distribution management system 12 of FIG. 3 is electrically connected with the server system 14, and the operation is similar to aforementioned in FIG. 4. The power distribution boards 126a, 126b is incorporated with the power distribution units 128a, 128b to reduce the accommodation space within the AC/DC power bank distribution management system 12. Similarly, the low-voltage DC is branch-outputted to each the server unit 142 of the server system 14 by the power distribution units 128a, 128b. Similarly, voltage of the low-voltage DC is branch-outputted to each server unit 142 by the power distribution units 128a, 128b is constant voltage. That is, the voltage of DC is converted by the power supply units 122a, 122b, 124a, 124b is 12 volts, the voltage of DC is passed through the power distribution units 128a, 128b is also 12 volt and the voltage of DC is branch-outputted to each server units 142 of the server system 14 by the power distribution units 128a, 128b is also 12 volts.

According to above discussion, for the AC/DC power bank distribution management system applied for server system as shown in FIG. 4 or in FIG. 5, the power consumption is usually generated in the power supply units 122a, 122b, 124a, 124b. When the power supply with AC or DC is converted into the low-voltage DC by the power supply units 122a, 122b, 124a, 124b, the low-voltage DC is transmitted from the output (not shown) of the power supply units 122a, 122b, 124a, 124b through the power distribution boards 126a, 126b and is transmitted to the server system 14 by the power distribution units 128a, 128b, the power consumption is supplied by the power distribution units 128a, 128b is the real power consumption of the server system 14 and the low-voltage DC with less power consumption from the power supply units 122a, 122b, 124a, 124b to the server system 14, such that the power supply efficiency for the server system 14 can achieve higher than 90%. Additionally, a fair electricity data can provide for the telecommunications system operators and the server system 14 to save the electricity expenses for the server system 14.

In addition, when the power source with AC or DC is converted to the low-voltage DC by the power supply units 122a, 122b, 124a, 124b, the voltage of the low-voltage DC is in the range of safety requirements, for the connection between entire AC/DC power bank distribution management system 12 to the server system 14, a user can perform in a safe range of the low-voltage operation. Therefore, when the maintenance staff required to replace the components such as the power supply units 122a, 122b, 124a, 124b, or the power distribution units 128a, 128b or the server device 14 in the AC/DC power bank distribution management system 12, since the operating voltage is low-voltage DC, so the maintenance staff does not to worry about the risk due to the high voltage electric shock, and when the AC/DC power distribution management system is still in operation, the maintenance staff can replace the failure component and did not turn off the entire AC/DC power bank distribution management system, so it will not affect the operation of the entire system.

Although specific embodiments have been illustrated and described, it will be obvious to those skilled in the art that various modifications may be made without departing from what is intended to be limited solely by the appended claims.

What is claimed is:

1. An AC/DC power bank distribution management system, comprising:
a power supply unit is electrically connected with a power source and converts the power source into a low-voltage DC;
a power distribution board is provided for receiving said low-voltage DC and outputting said low-voltage DC according to a transmission mode of said power distribution board; and
a power distribution unit is electrically connected with said power distribution board which is provided for receiving said low-voltage DC from said power distribution board and is provided for monitoring, measuring and branch-outputting said low-voltage DC.

2. The AC/DC power bank distribution management system according to claim 1, wherein said low-voltage DC with a voltage is in range from 10 volts to 24 volts.

3. The AC/DC power bank distribution management system according to claim 1, wherein said power supply is alternating current (AC) or direct current (DC).

4. The AC/DC power bank distribution management system according to claim 1, wherein said transmission mode of said power distribution board includes a parallel mode, a redundant mode and a parallel/redundant common mode.

5. The AC/DC power bank distribution management system according to claim 1, wherein said power distribution board includes the protection function of over-voltage (OVP), over-current (OCP), under-voltage (UVP) and short circuit and monitors a connection signal between said power supply unit, said power distribution board, said power distribution unit and server system to determine said power supply unit that is executed to provide said power supply.

6. The AC/DC power bank distribution management system according to claim 1, wherein said power distribution unit electrically connected with a server system to provide said server system to determine and to calculate amount of said low-voltage DC data and said server system includes at least one server unit.

7. The AC/DC power bank distribution management system according to claim 1, wherein said power distribution unit provides the protection function of over-voltage, over-current and over-temperature, under-voltage and short circuit.

8. An AC/DC power bank distribution management system is applied for a server system, comprising:
a power supply unit is electrically connected with a power source and converts said power source into a low-voltage DC;
a power distribution board is provided for receiving said low-voltage DC from said power supply unit and outputting said low-voltage DC according to a transmission mode of said power distribution board;
a power distribution unit is electrically connected with said power distribution board and is provided for receiving said low-voltage DC from said power distribution board and monitoring, measuring and branch-outputting said low-voltage DC; and
a server system is electrically connected with said power distribution unit and includes at least one server unit, said server system is provided for receiving said low-voltage DC is branch-outputted from said power distribution unit, said power distribution unit is provided for detecting and calculating a usage amount of data of said low-voltage DC by said server system, wherein a loading voltage of a motherboard within said server unit is corresponding to a voltage of said low-voltage DC which is transferred from said power distribution unit.

9. The AC/DC power bank distribution management system is applied for the server system according to claim 8, wherein said low-voltage DC with a voltage is in range from 10 volts to 24 volts.

10. The AC/DC power bank distribution management system is applied for a server system according to claim 8, wherein said power source is AC or DC.

11. The AC/DC power bank distribution management system is applied for the server system according to claim 8, wherein said transmission mode includes a parallel mode, a redundant mode, and a parallel/redundant common mode.

12. The AC/DC power bank distribution management system is applied for the server system according to claim 8, wherein said power distribution board includes the protection function of over-voltage (OVP), over-current (OCP), under-voltage (UVP) and short circuit and monitors a connection signal between said power supply unit, said power distribution board, said power distribution unit and server system to determine said power supply unit that is executed to provide said power supply.

13. The AC/DC power bank distribution management system is applied for the server system according to claim 8, wherein said motherboard with a voltage within said server unit is in range from 10 volts to 24 volts.

14. An AC/DC power bank distribution management system is applied for the server system, comprising:
a power supply unit is electrically connected with a power source and converts said power supply into a low-voltage DC;
a power distribution unit is electrically connected with said power supply unit, said power distribution unit is provided for receiving said low-voltage DC and monitoring, measuring and branch-outputting said low-voltage DC according to a transmission mode of said power distribution unit; and
a server system is electrically connected with said power distribution unit, said server system includes at least one server unit and is provided for receiving said low-voltage DC which is branch-outputted from said power distribution unit and said power distribution unit is provided for detecting and calculating a usage amount of data of said low-voltage DC by said server system, wherein a loading voltage of a motherboard within said server unit is corresponding to a voltage of said low-voltage DC which is transferred from said power distribution unit.

15. The AC/DC power bank distribution management system is applied for the server system according to claim 14, wherein said low-voltage DC with a voltage is in range from 10 volts to 20 volts.

16. The AC/DC power bank distribution management system is applied for the server system according to claim 14, wherein said power supply is AC or DC.

17. The AC/DC power bank distribution management system is applied for the server system according to claim 14, wherein said transmission mode includes a parallel mode, a redundant mode, and a parallel/redundant common mode.

18. The AC/DC power bank distribution management system is applied for the server system according to claim 14, wherein said power distribution board includes the protection function of over-voltage (OVP), over-current (OCP), under-voltage (UVP) and short circuit and monitors a connection signal between said power supply unit, said power distribution board, said power distribution unit and server system to determine said power supply unit that is executed to provide said power supply.

19. The AC/DC power bank distribution management system is applied for the server system according to claim 14, wherein said motherboard with a voltage within said server unit is in range from 10 volts to 24 volts.
